(19) United States
(12) Patent Application Publication
(10) Pub. No.: US 2005/0071252 A1
(43) Pub. Date: Mar. 31, 2005

(54) Utilization of accumulated customer transaction data in electronic commerce

(76) Inventors: Keith Henning, Austin, TX (US); Brett A. Hurt, San Francisco, CA (US)

Correspondence Address: TOLER & LARSON & ABEL L.L.P., 5000 PLAZA ON THE LAKE STE 265, AUSTIN, TX, 78746, US

(21) Appl. No.: 10/995,604

(22) Filed: Nov. 22, 2004

Related U.S. Application Data
(63) Continuation of application No. 09/679,334, filed on Oct. 4, 2000.
Application No. 09/679,334 is a continuation-in-part of application No. 09/526,754, filed on Mar. 16, 2000.

(51) Int. Cl. G06F 17/60

(52) U.S. Cl. 705/26

(57) ABSTRACT

In accordance with a particular embodiment, the present disclosure is directed to a system including a web page that is downloadable from a web server to an e-commerce customer computer. The web page includes at least one image to be displayed on the e-commerce customer computer. The web page also includes a personalized content delivery code to be executed by the e-commerce customer computer that causes the e-commerce customer computer to send a query to a content management server that includes the identity of the e-commerce customer. The system also includes a content management server to receive the query from the e-commerce customer computer via a communications network, the content management server storing customer attributes and identifying personalized content to be communicated to the e-commerce customer computer based on the customer attributes. The content management server delivers the personalized content based upon an identity of an e-commerce customer.

### PRIORITY CLAIM TO RELATED APPLICATION

This is a continuation application of U.S. patent application Ser. No. 09/679,334 filed on Oct. 4, 2000, which is a continuation-in-part of U.S. patent application No. 09/526,754, filed on Mar. 16, 2000, the contents of both of which are expressly incorporated herein by reference in their entirety.

### BACKGROUND OF THE INVENTION

I. Field of the Invention

The present invention relates generally to electronic commerce. Particularly, the present invention relates to the accumulation and use of data regarding potential customers from various sales channels.

II. Description of the Related Art

The popularity and use of the Internet (World-Wide-Web “WWW”) continues to increase dramatically with time. While electronic commerce (e-commerce) across the Internet is a relatively recent development, e-commerce sales already represent a substantial portion of overall sales. While some e-commerce sellers sell only via the Internet, other e-commerce sellers maintain conventional stores and sell over the Internet as well.

Traditional advertising and sales theories, however, do not always readily apply to e-commerce sales. Using conventional methods, advertisers create advertising content that is directed toward a particular type of potential customer and is placed in a particular medium. For example, advertisements for golf clubs are shown on television during golfing tournaments or in golfing magazines but are not broadcast at most other times. While advertisement upon the Internet has become substantial, little basis exists for targeting advertisements to particular types of potential customers or for validating the success of advertising campaigns.

Some attempts have been made to correlate the content of a particular web page being viewed by a prospective customer with advertising content presented therein. For example, a prospective customer viewing a web page listing scores of baseball games may be provided with an advertisement and link to a web site that sells athletic equipment. As a further example, a prospective customer viewing a web page providing information regarding infants may be provided with an advertisement and link to a web site that sells baby products. Unfortunately, this type of correlation is prone to errors and has produced little historical success.

Further, determining which e-commerce advertisements or promotions are successful is also difficult, if not impossible to determine. Such is the case because correlation between e-commerce advertisements and e-commerce sales cannot be easily determined. Only when a customer performs a direct click-through from an advertisement to an on-line purchase is it possible to determine that the advertisement corresponds directly to a sale. In most, if not all other advertising situations, the success of an advertising campaign is indeterminable.

E-commerce presents its own unique difficulties in attempting to close sales. The very nature of e-commerce precludes common types of techniques used to close sales. Conventional stores typically employ sales people to assist customers in selecting and purchasing products. The sales people present purchase options to customers, receive feedback from the customers, and, based upon the feedback, are able to take steps to close the sale. In an e-commerce transaction, however, customers are able to view a wide range of product offerings without traveling to different physical locations. The prospective customer operates alone, without any assistance in making the decision whether to purchase a product. Thus, no representative of the seller is able to close the sale. Various studies have shown that many e-commerce shoppers select items for purchase, place them in their electronic shopping cart, and prepare to make the purchase only to change their mind at the last minute.

Some retailers' sales efforts were first in e-commerce and then they expanded their efforts into traditional commerce, e.g., bricks-and-mortar stores, catalog sales, co-branding, etc. Other retailers engaged in conventional commerce first and then ventured into e-commerce. In each of these cases, the retailers now make sales using both conventional commerce and e-commerce. Many customers of these retailers purchase using both the retailers commerce and e-commerce sales channels. However, advertising and sales efforts are typically directed only to one of these types of commerce. Thus, the retailers are missing important opportunities to influence the buying decisions of these cross-commerce shoppers. A need therefore exists to identify all customers and their full purchasing activities so that the retailers may direct advertising and sales efforts to obtain more business.

### SUMMARY OF THE INVENTION

The present invention encompasses a process for accumulating consumer sales transaction data that is gathered from a plurality of different sales transaction sources. Once accumulated, the data is segmented and used for focused consumer advertising. A plurality of sales transaction sources from which the data is collected include physical stores, mail order stores, Internet e-commerce companies, and related services companies. Each source has a consumer sales transaction database server.

The process begins by standardizing the consumer sales transaction data in order to place the consumer sales transaction data into a predetermined format. In one embodiment, a semicolon or other type of data field delimiter delimits the data. The standardized data is stored on a computer server that is comprised of some form, or multiple forms, of memory. This memory can include hard disks, tape drives, CDROM drive, and solid-state memory.

The consumer data is accumulated such that a group of the consumer sales transaction data relating to a specific consumer is assigned to that consumer in the form of a data file on that particular consumer. The accumulated data files are then segmented to create a group of consumers defined by that group's characteristics.

Moreover, other aspects of the present invention will become apparent with further reference to the drawings and specification, which follow.

### BRIEF DESCRIPTION OF THE DRAWINGS

A better understanding of the present invention can be obtained when the following detailed description of the preferred embodiment is considered in conjunction with the following drawings, in which:

FIG. 1 is a system diagram illustrating a web based personalized content delivery system constructed according to the present invention;

FIG. 2 illustrates is a particular embodiment of a web based personalized content delivery system constructed according to the present invention;

FIG. 3 is a logic diagram generally illustrating operation of a web based personalized content delivery system according to the present invention;

FIG. 4 is a logic diagram illustrating operation of a customer computer in seeking and obtaining personalized content according to the present invention;

FIG. 5 is a logic diagram illustrating operation of a load balancing server and a content management server according to the present invention;

FIG. 6 is a logic diagram illustrating operation of a data aggregation server according to the present invention;

FIG. 7 is a logic diagram illustrating operation of a content management interface server according to the present invention;

FIG. 8 is a block diagram illustrating a server computer constructed according to the present invention;

FIG. 9 is a block diagram illustrating a particular embodiment of a data accumulation and segmentation system of the present invention;

FIG.10 is a flowchart illustrating a process of data accumulation and segmentation in accordance with the system of FIG. 9;

FIG. 11 is a flowchart illustrating a process that uses the accumulated/segmented data in accordance with the system of FIG. 9;

FIG. 12 is a block diagram illustrating a system in which targeted advertising is employed to reach a customer;

FIG. 13 is a flowchart illustrating a process in accordance with FIG. 12;

FIG. 14 is a system diagram illustrating an alternate embodiment of a personalized content delivery system constructed according to the present invention in which content is accessed and delivered via separate networks;

FIG. 15 is a system diagram illustrating another alternate embodiment of a personalized content delivery system constructed according to the present invention in which a first system server group services a single client and a second system server group services a plurality of clients; and

FIG. 16 is a system diagram illustrating still another embodiment of a personalized content delivery system constructed according to the present invention in which radio frequency watermarks are employed in delivering personalized content.

### DETAILED DESCRIPTION OF THE PREFERRED EMBODIMENT

The present invention provides a company with the ability to accurately target potential customers with focused advertisements. By accumulating data from various sources and media, an accurate database of information can be accumulated regarding a pontential customer's spending habits.

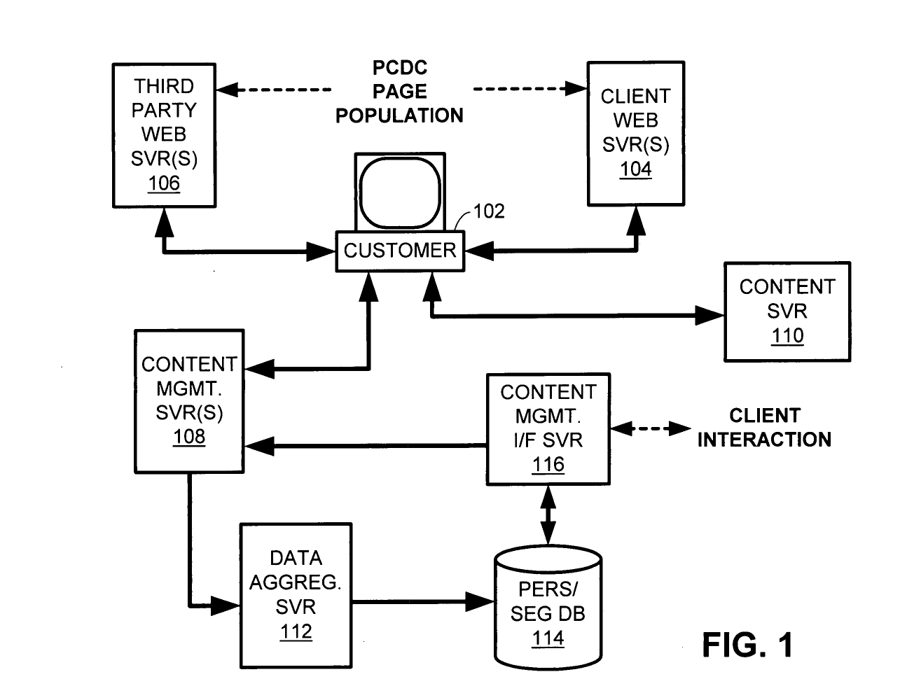

FIG. 1 is a system diagram illustrating a web based personalized content delivery system constructed according to the present invention. The personalized content delivery system includes at least one content management server (108), a data aggregation server (112), a personalization/segmentation database (114) and a content management interface server (116). Personalized content delivery code (PCDC) is loaded into web pages stored on client web servers (104) and is loaded into web pages stored on third party web servers (106) that service the clients.

In the preferred embodiment, the PCDC is JavaScript and/or HTML code. Alternate embodiments use other differing types of code for the PCDC.

A client is a company or other entity that is engaged in commerce, including e-commerce. Clients may host on-line stores at which customers purchase goods and services over the Internet. In providing their on-line stores, clients provide a number of web pages on their client web servers (104). Each web page may correspond to a particular item for sale, a particular category of items for sale, sales checkout pages, product search pages, or other types of WWW pages.

In other embodiments, clients may be engaged businesses such as portals, chat rooms, application service providers, search engines, and other Internet based operations. In these embodiments, the clients provide content that is not necessarily directed toward e-commerce. For example, the content provide may be an on-line newspaper, magazine or other content source. In these embodiments, content is personalized for a customer accessing the system.

In an example of an e-commerce embodiment, a client pays to have its web pages, banners, or other content displayed on a third party web server (106). The third party web server may be a portal, a search engine, a non-competing e-commerce site, or another site at which the client desires to advertise. Customers and potential customers of the client visit the client's web servers (104) and third party web servers (106) during web surfing or e-commerce. In a preferred embodiment, the customer uses a customer computer (102), running a browser program such as NETSCAPE, to access the web. The browser program is well known in the art and is not discussed further. In alternate embodiments, the customer uses other types of devices when accessing the client web servers (104) and third party web servers (106). These devices include personal data assistants, web-enabled telephones, laptop computers, net appliances, web-enabled televisions, and other electronic devices that have the ability to download web pages from web servers across a data network.

PCDC may be loaded into each web page or banner that makes up a portion of a web page. The client may take steps to load the PCDC into these web pages during setup of the web pages, or portions thereof. Because the PCDC applies equally to all customers that access the web pages, it may be easily entered into all web pages on a site. Alternately, if the client implements the system of the present invention after its e-commerce site has been built, the content management server (108) or the content management interface server (116) may be used to load the PCDC into the web pages or portions thereof.

When a customer accesses a web page that has been populated with the PCDC, the customer's browser executes the PCDC contained in the web page. Upon execution of the PCDC, the customer's computer (102) sends a query to the content management server(s) (108), in which the PCDC identifies the client, a secondary identifier that reveals additional information about the customer's access (e.g., the client's web page being accessed, an advertisement ID, a sales campaign ID) and the identity of the customer/customer computer.

A cookie or other type of identifier stored on the customer's computer (102) provides the customer/customer computer identity. The query may also include additional information relating to the interaction between the customer and the particular web page that has been populated by the PCDC. Other types of identifiers include, for example, a MAC identifier associated with a computer, a computer's serial number, a computer's IP address, a cellular telephone's mobile identification number (MIN), a cellular telephone's telephone number, a web enabled telephone's telephone number, or any other unique ID associated with the customer computer 102.

In response to some or all of the information contained in the query, the content management server(s) (108) performs a table lookup (or other logical operation) based upon the information contained in the query and receives the address of personalized content to be displayed to the customer or executed by the customer computer. In other embodiments, a rules application or other logic operation may be performed instead of a table lookup. This operation simply identifies content based upon the query.

Then, according to one operation, the content management server (108) returns an IP address (and file name) of the personalized content to the customer's computer (102). The personalized content may include one or a combination of HTML, JavaScript, XML, and other languages that render in a web browser program. In other embodiments, the personalized content may be an audio file, a video file, streamed multimedia content, or other content that the client desires to deliver to the customer. In still another embodiment, the content management server (108) pushes personalized content back to the customer's computer (102) in response to the query.

The customer's computer (102) receives the personalized content address and processes it accordingly. When the customer's computer (102) receives the address of an image, it downloads the image from the content server (110), for example, and displays the image to the customer. The personalized content may be displayed within a designated location of the web page that was downloaded from the client web server (104) or the third party web server (106). When the customer's computer (102) receives the address of an executable file, the customer's computer (102) retrieves the executable file and executes it for the customer. This executable file may also be downloaded from the content server (110).

After the content management server (108) sends the result to the customer's computer (102), it may also send a record to the data aggregating server (112) that includes information, such as the identity of the client, the identity of the web page visited, the identity of the customer, and/or other information pertinent to the customer's web page visit. Periodically, or upon request, the data aggregation server (112) formats this information and passes the information to the personalization/segmentation database (114). This information is archived for subsequent use.

Via client interaction, and by using data contained in the personalization/segmentation database (114), the content management interface server (116) creates the tables, rules, or other logic that are later used to determine the personalized content to be provided to particular customers. By using the set of tools available on the content management interface server, the client may review pertinent customer information. This customer information may reveal the numbers of customers that have visited the client e-commerce site, how the customers came to the site, e.g., directly or via a third party web server, the manner in which the customers behaved once at the client's e-commerce site, whether the customers purchased goods from the e-commerce site, and additional customer information.

Segmentation is a technique for identifying a group of customers by defining the group's characteristics. For example, a segment can be defined as “all the visitors who bought at least once from their site”, “people who have visited their site more than once”, or “people who are first time visitors to their site”.

Internal content delivery means showing banner ads or personalizing ads, content, etc., within the client's website. External personalized content delivery means running clients' banner ads on third party web sites such as content sites, portals, search engines and other sites.

Based upon the gathered information, the client may segment the customers and select particular personalized content to be sent to each segment of customers when they next visit a particular site, web page, or portion thereof. This segmentation may be on a user-by-user basis, on a group of users basis, or based on other criteria. With this segmentation established, the content management interface server generates tables, rules, or other logic that the content management server(s) (108) will subsequently use to provide content to the customers.

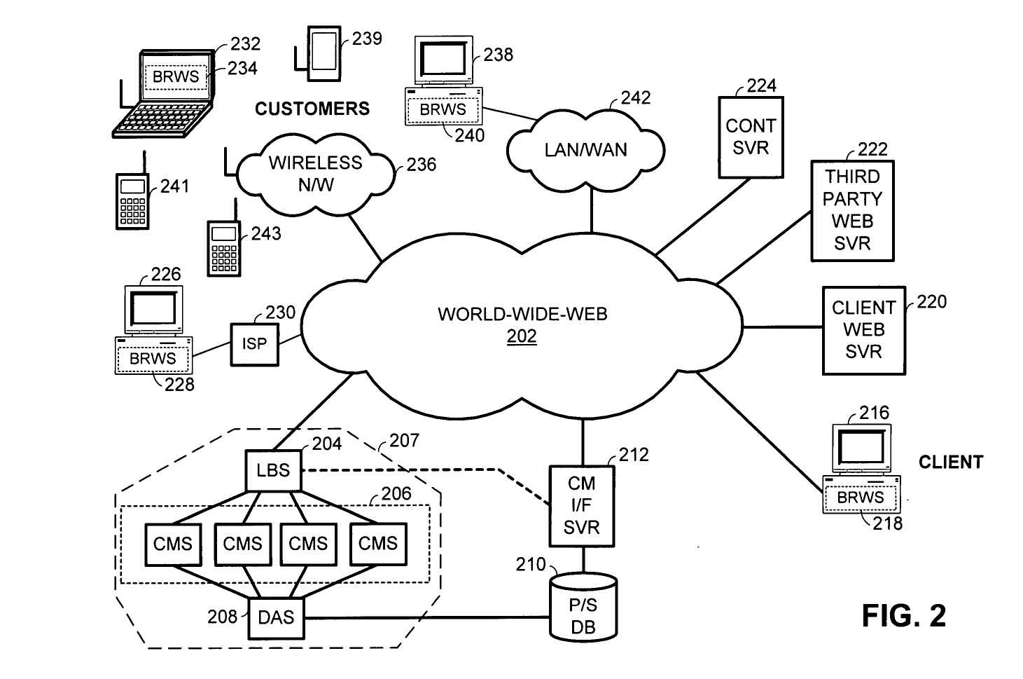

The illustrated architecture of the content server (110), the data aggregating server (112), the personalization/segmentation database (114) and the content management interface server (116) illustrated in FIG. 1 (and that which is illustrated in FIG. 2) are particular embodiments only.

Alternate embodiments use different structures to perform the functions described herein according to the present invention. For example, each of the servers illustrated may be implemented by a plurality of separate machines. In yet another embodiment, each of the illustrated servers could be combined so that their functions are performed by a lesser number of machines than the number of servers illustrated.

Generally speaking, personalization may be described as customizing or tailoring Banner Ads, Promotions, and other Content to individual customers in an attempt to make sales to the customers. This type of personalization is very important in the highly competitive e-commerce marketplace.

It does not make sense to provide an advertisement for a discount on winter clothing to a customer searching for a swimsuit. Personalization helps sellers identify individual customers visiting their sites, or potentially visiting their sites, and to tailor the seller's promotional ads or other content delivered to the customer or potential customer based on past shopping behavior in an attempt to make a sale. The personalization process therefore increases the chances of making a sale to a customer.

Another example of the use of personalization is in connection with personalized marketing to measure the success of particular advertising campaigns. For example, a segment may be defined as “visitors that have visited the customer's e-commerce site more than once”. A goal of this personalization is to determine how repeat visitors react to various promotional banners, e.g., in a golf shop website. One control group and three test groups are set up to test the response. In the control group of the segment, no discount banner is served. In the first test group, a 10% off banner is served. In the second test group, a 20% banner is served. In the final test group, a $25 off banner is served. These discounts are then applied to purchases made by respective customers. For 100,000 “repeat visitors”, 25,000 customers receive the control group banner, 25,000 customers receive test group 1 banner, etc.

Segmentation of the customers into the four groups allows the effect of the distribution of a selected banner ad to each segment. When a customer visits the client's corresponding web page, the system determines which segment the customer falls within by analyzing the customer's cookie or other unique customer identifier. If the customer does not fall into the defined segments, then he or she will be served with a default banner. If the customer falls into any of the segments listed, he or she will be served with a banner or other personalized content designated for the segment. All customers falling within a particular segment receive the same banner. If a customer falls into multiple segments within the personalization, a priority will be determined for content delivery. Results may then be subsequently traced for the particular segmentation and the effectiveness of each advertisement can be judged.

FIG. 2 illustrates a particular embodiment of a web based personalized content delivery system of the present invention. In the illustrated embodiment, a plurality of content management servers (206) couple to the Internet/world-wide-web (WWW) (202) via a load-balancing server (204). A data aggregation server 208 couples to each of the content management servers 206. In combination, these servers (204), (206) and (208) are referred to as a system server group (207). Each system server group (207) may service a single client or a plurality of clients. A system server group (207) may be managed by a service provided or by a client. System server groups (207) may be deployed, expanded, removed, etc. to meet the varying demands required of the system of the present invention.

For each received query, the load-balancing server (204) routes communications to a designated content management server of the plurality of content management servers (206). Each of the content management servers (206) also couples to a data aggregation server (208).

The data aggregation server (208) couples to the personalization/segmentation database (210). A content management interface server (212) couples to the personalization/segmentation database (210). The content management interface server (212) also couples to the WWW (202) and may couple to the load-balancing server (204) (or content management servers (206)) via another connection, e.g., LAN, WAN, etc.

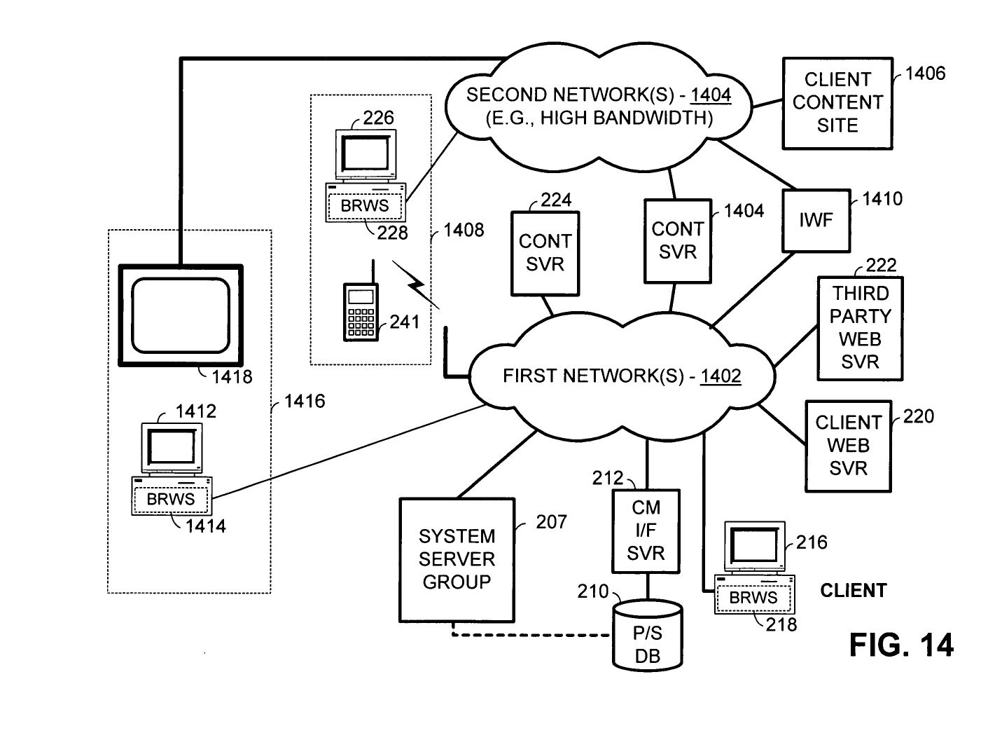

Third party web server (222), client web server (220) and content server (224) also couple to the WWW (202). These servers, as well as the other servers, may be at any physical location. Customers may couple to the servers in any of a variety of manners. For example, customer's computer (226) running browser (228) may couple to the WWW (202) via an Internet service provider (230). Customer's computer (238) running browser (240) may couple to the WWW (202) via a Local Area Network or Wide Area Network (242). Moreover, customer's computer (232) running browser (234) may couple to the WWW (202) via a wireless network (236). The customer's computer may be another type of electronic device as well that can access the WWW (202) and download web pages from the third party web server (222) or the client web server (220). Alternate embodiments of the customer's computer could be a personal data assistant (239) that couples via a wireless connection, data enabled telephones (241) and (243), a web-enabled television (shown in FIG. 14) and other data enabled devices.

Depending upon the type of customer's computer (or other data device) employed by the customer, the overall communication link character, connection topology, and other communication link characteristics will differ. However, generally speaking, the customer's computer is initially in communication with the client web server (220) or the third party web server (222) when accessing a web page. Subsequent to his web page access, the customer's computer communicates with the content management server(s) (206) to send the query and in receiving the response to the query. In the architecture of FIG. 2, the customer's computer communicates with the content management server(s) (206) via the load-balancing server (204). However, load balancing among the content management server(s) (206) may be performed using other techniques, such as unique URLs to each content management server (206), an operation of a domain name server to identity a serving content management server, etc. Subsequent to receipt of the query, the customer's computer is then in communication with a resource, e.g., the content server (110), from which the personalized content is retrieved.

In an example of operation according to the present invention, customer's computer (226) accesses a web page contained on client web server (220). The downloaded web page contains executable PCDC, which upon execution generates a query to the load-balancing server (204). The query, in this example is directed to the WWW address of the load-balancing server (204) and includes a path name to a particular directory and resource that is contained on a corresponding content management server (206). An example of such a query would have the address: http://expedite.coremetrics.com/clientID/cginame/clientID/expid/type. The query will include additional information as well, such as the type of content of the site visited, the time stamp of the customer's computer (226), a third party banner supplier, etc. Via interaction with a domain name server, the URL “expedite.coremetrics.com” enables routing of the query to the load-balancing server (204) (or directly to a designated content management server (206)). The load-balancing server (204) receives the query, parses the query to read the first instance of “clientID” and, based upon the “clientID”, the load-balancing server (204) routes the query to a particular content management server of the plurality of content management servers (206).

The particular content management server (206) then uses the query address to access a lookup table (or other data structure) corresponding to the clientID and expID (client advertising campaign, promotion identification or other subset created by the client) stored in the CGI name directory corresponding to CGIname. The CGI directory stores common gateway interface executable files, each of which corresponds to a particular client and expID. In some cases, a client will not have separate expIDs and a single CGI executable will be employed for all queries corresponding to the client. In one embodiment, the lookup table is a hash table (a structured data set for an in-memory database) and a cookieID, that uniquely identifies the customer and that is received with the query, is used as an input to the hash table. The table lookup returns the address of, pointer to, or other identification of the personalized content. The personalized content may be an image, a banner advertisement, an audio file, a video file, a multimedia stream, etc. Further, the address of the personalized content may be an Internet address, a pointer, a pointer to a pointer, or another item that may be used to retrieve the particular personalized content.

The browser (228) operating on the customer's computer (226) receives the address of the personalized content, retrieves the image or executable based upon the address, and displays the image or executes the executable on the customer's computer 226. Within the content returned to the customer's computer is the clientID (client identification), the expID (if any), the cookieID (customer identification), the bannerID (location on the web page in which to display content, if required), the personalized content type (image or executable) and the destination URL of the image or executable. In an alternate embodiment, the content management server returns the personalized content to the customer's computer (226) instead of the image/executable address.

Concurrent with returning the content to the customer's computer (226), the content management server (206) may write a record of the transaction to the data aggregation server (208). A record may be created every time the content management server (206) responds to a query. Alternately, the records may be created to obtain a statistical representation of customer behavior, in which case records are not created for each query response. This record is written to a text file and includes the clientID, the expID, the cookieID, the bannerID, and the personalized content type. As was previously described, this text file will periodically be converted into database records that are stored on the personalization/segmentation database (210). In an alternate embodiment, each time a record is created by the content management server (206), a database record is created that is in a format that may be received by the personalization/segmentation database (210). The database records may be transferred to the personalization/segmentation database (210) upon their creation or they may be held by the content management server (206) and downloaded to the personalization/segmentation database (210) periodically or upon the occurrence of a triggering event.

In other operations according to the present invention, the query from the customer device, e.g., web enabled telephone (241) provides in its query the MIN of the telephone (241). The MIN of the telephone (241) along with other information regarding the client is employed to identify content for the customer. The identity of this content is then returned to the telephone (241) for subsequent use.

In another operation according to the present invention, a client, using the client computer (216), with the browser (218) accesses the content management interface server (212) across the WWW (202) in setting up campaigns and to review the activity of his or her customers. While the client may access the content management interface server (212) at any time to setup campaigns, e.g., segmentations and other personalized content direction, the client's continued participation is not required to keep the system current. Based upon the client's most recent input, the content management interface server (212) periodically (every one to six hours, for example), or upon a manual operation, generates updated tables to perform the personalization/segmentation operations.

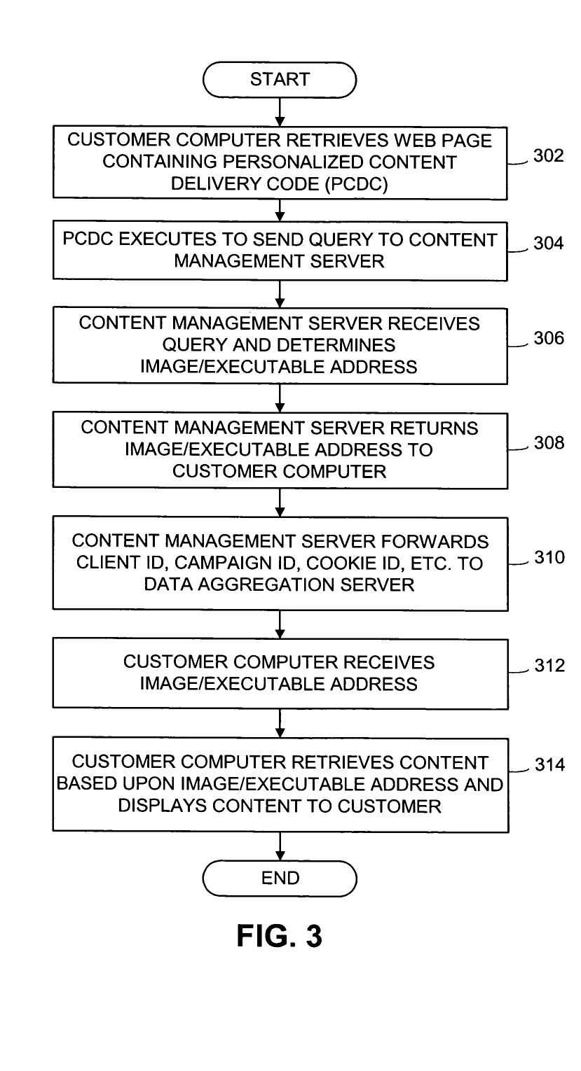

FIG. 3 illustrates a logic diagram of the operation of a web based personalized content delivery system of the present invention. Operation commences wherein a customer's computer retrieves a web page that has been populated with PCDC (step 302). The PCDC is received by a browser on the customer's computer and executed. Upon its execution, the PCDC causes the customer's computer browser to send a query to a corresponding content management server (step 304).

The content management server receives the query, performs a table lookup (or other lookup operation) based upon the query and determines the address of personalized content (image or an executable file) that will be used for the personalization operation (step 306). In one embodiment, the database used for the lookup corresponds to a particular client and segment, e.g., campaign ID, of the client. The table lookup itself uses an index that identifies the particular customer. If the customer is not represented in the database, a default result is returned. The default result would be returned for a first time visitor to the site or to the web page.

In an alternate embodiment, characteristics of the particular customer or characteristics of the particular web page the customer is visiting are used in the table lookup. Customer characteristics may be captured by a cookie residing upon the customer's computer, the cookie having been generated upon the customer's visit to the client's website. In one embodiment, the PCDC executed for present operation extracts relevant information from the cookie (or other characteristics of the customer gathered from the customer's computer) and returns this information to the content management server. This information is then used in the table lookup operation. Other criteria may also be employed in selecting content to be provided to the customer, e.g., time of day, physical location of customer, type of computer the customer is using, etc.

After retrieving the address and type of content to be displayed to the user, the content management server returns the address of the personalized content to the customer's computer along with an indication of the type of content and additional required information (step 308). The content management server may then forward a record of the transaction to the data aggregation server, the record including information such as the clientID, the campaign ID (expID), cookieID and/or other relevant information (step 310).

The customer's computer receives the personalized content address from the content management server along with the additional content of the response (step 312). The browser operating on the customer's computer then retrieves the personalized content based upon the address received from the content management server. When the personalized content is an image, the customer's computer displays the image to the customer within the web page that had been previously downloaded from the client web server or third party web server (step 314). Alternately, when the personalized content is an executable file, the customer's computer executes the executable file thereby displaying the content to the customer.

The personalized content may comprise a combination of HTML, JavaScript, and other language that render in a web browser program. However, the personalized content may also be an audio file, a video file, streamed multimedia content, or other content that the client desires to deliver to the customer.

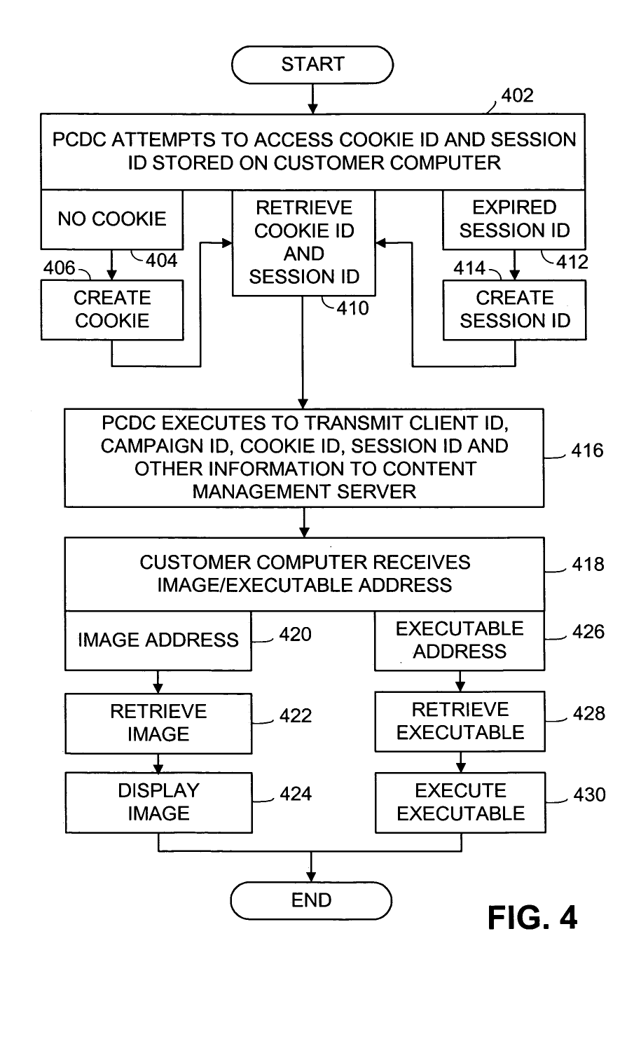

FIG. 4 is a logic diagram illustrating operation of a customer's computer in seeking and obtaining personalized content according to one embodiment of the present invention. Operation commences when a customer accesses a web page that contains PCDC.

The PCDC executes so that the customer's computer attempts to access the cookieID and sessionID that may have been previously stored in a cookie on the customer's computer (step 402). If this is the first client web page that the customer has accessed, no cookie will exist for the client (step 404) and the PCDC creates a cookie (step 406). Because the customer has no unique identity with respect to the client, a cookieID must be also be obtained. In one embodiment, the content management server creates unique sequence numbers that serve as cookieIDs.

These cookieIDs are then sent to the client web server for assignment to new customers. In this embodiment, the customer's computer requests and receives a cookieID from the client web server as part of its query. In an alternate embodiment, the PCDC directs the customer's computer to access another server computer, e.g., the content management server, to obtain a cookieID. This access may be contained in the query sent from the customer's computer to the content management server.

The sessionID is a customer ID that is valid for a particular time period, e.g., twelve (12) hours, and serves to correlate events occurring during a particular session that the customer has with the client's web site. The sessionID is created by the PCDC and includes the clientID, the cookieID, the Internet Protocol (IP) address of the customer, and a time stamp. Each time that the customer accesses a web site that includes PCDC, the PCDC accesses the respective cookie to determine whether a current sessionID exists. The cookie may be valid across multiple client web sites and serve to identity a particular customer across the multiple clients web sites. If the most recent sessionID is expired, or if no sessionID exists (step 412), the PCDC creates a sessionID and writes the sessionID to the cookie (step 414).

Cookies may be encrypted when sent across the Internet to and from the client computer using PK1 or another encryption type. Further, because cookies may be modified or their function limited by customers, it may be desirable to make copies of cookies and maintain the cookie copies remotely from the customer's computer for future reference.

When both a cookieID and a current sessionID have been created, the PCDC retrieves the cookieID and the sessionID (step 410). Then, the PCDC executes to transmit a query to the content management server (step 416), the query including the clientID, the cookieID, the sessionID, and other information that the PCDC deems to be required. If the client has more than one advertising campaign, the query may include the expID (campaignID) as well. As was previously discussed, personalized content may be chosen based upon the customer's identity (cookieID). However, in other operations, the personalized content may be selected based upon other criteria gathered by the PCDC such as customer demographics, customer's computer characteristics, and web page characteristics, among other criteria.

The customer's computer then waits for a response from the content management server; the response including the address or other identity of an image or executable file (personalized content) that the customer's computer is to display/execute (step 418). When the response includes the address of an image (step 420), the customer's computer retrieves the image (step 422) and displays, streams or otherwise delivers the content to the customer (step 424). When the response includes the address of an executable (step 426), the browser on the customer's computer retrieves the executable (step 428) and executes the executable (step 430) to provide the content to the customer. In providing the content to the customer on the customer's computer, interim steps may be required, depending upon the type of personalized content retrieved. For example, to present streamed multimedia to the customer, a streaming multimedia player must be obtained and launched. As another example, when the personalized content is an audio or video file, an appropriate player must be obtained and launched to enable presentation of the personalized content to the customer. From both steps 424 and 430, operation ends.

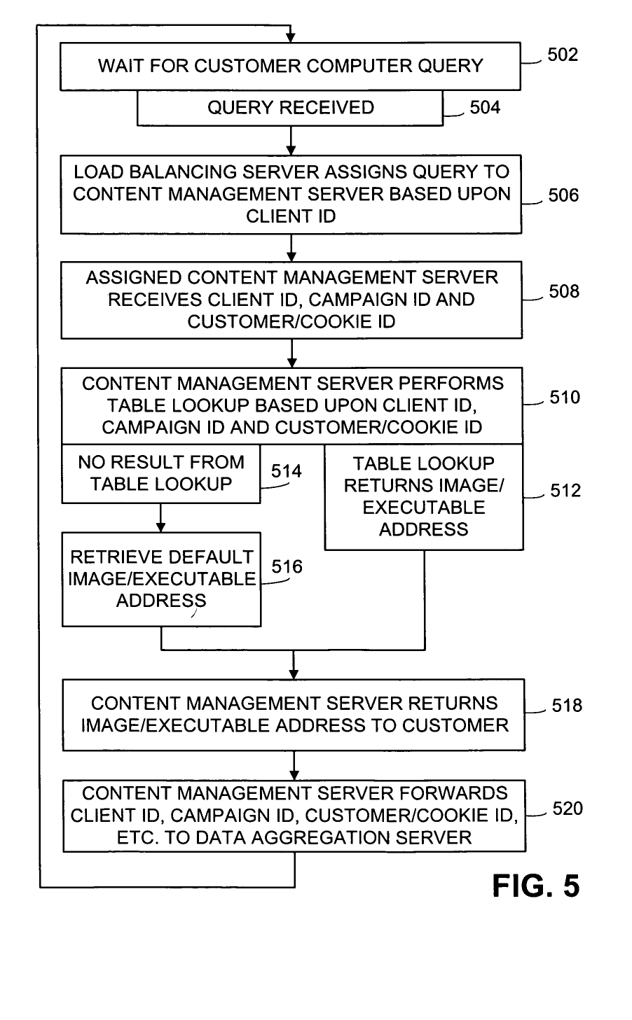

FIG. 5 is a logic diagram illustrating operation of a load balancing server and a content management server, both according to the present invention. As a first described operation, the content management server waits for a query from a customer's computer (step 502). Upon receipt of a query from a customer's computer (step 504), the load-balancing server assigns the query to a content management server based upon the clientID (step 506). In a typical installation, one content management servers may service a plurality of clients. However, for heavier traffic installations, one or more content management server may be required to service a single client. When multiple content management servers service a single client, the load-balancing server uses reference to the expID (campaignID) in selecting a content management server. When the load-balancing server is not employed, step 506 is not performed.

The content management server then performs a table lookup (or other lookup operation) based upon the clientID, expID, and cookieID. In the described embodiment, a single hash table is created for each clientID/expID pair and the cookieID serves as the lookup index for the hashing function. When hashing the cookieID does not yield a result from the table lookup operation (step 514), the content management server retrieves a default address for an image or for an executable file (step 516). Otherwise, the table lookup operation returns the address of an image or executable file (step 512).

The content management server then returns the address of the image or executable to the customer's computer along with additional information (step 518). In an alternate embodiment, the content management server returns the image or executable file to the customer's computer. Once this operation is complete, the content management server forwards the clientID, the expID, the cookieID, and additional required data to the data aggregation server for further processing (step 520). From step 520, operation returns to step 502.

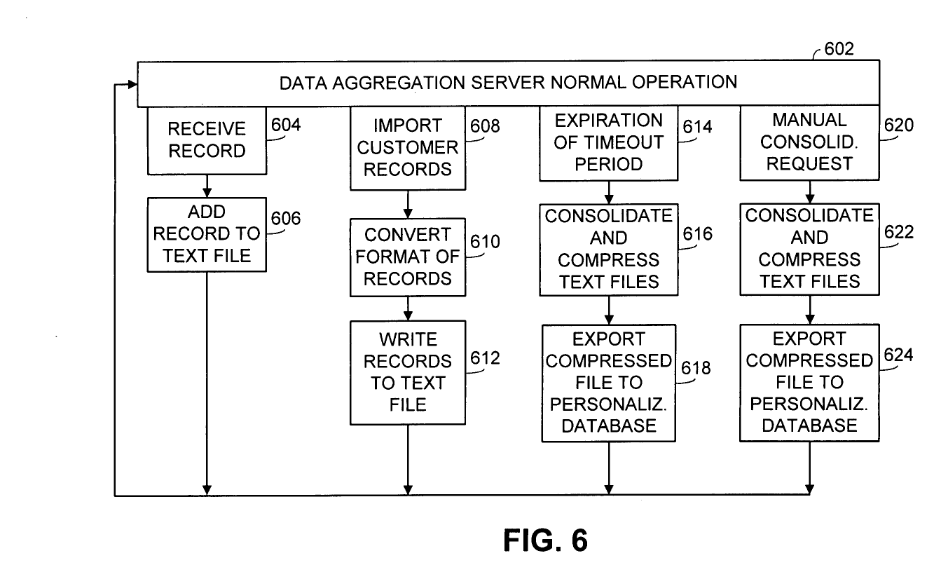

FIG. 6 is a logic diagram illustrating operation of a data aggregation server according to the present invention. From the normal operating state of the data aggregation server (step 602), various operations may take place, some of which are described with reference to FIG. 6. As a first operation, the data aggregation server receives a record from a content management server (step 606). Upon receipt of the record, the data aggregation server adds the record to a text file that either contains, or will contain other records received from the same content manager server or other content management servers.

In another operation, the data aggregation server imports customer records that are of another format (step 608). The client at its web site may have collected these customer records over time. Upon commencing operation with the system of the present invention, the client desires to retain these records and thus imports these records. Upon receiving these records, the data aggregation server converts the format of the received records into a format compatible with the personalization/segmentation database (step 610). In the described embodiment, the records are converted (step 612) into a text file that is compatible with the text file format created at step 606.

Periodically, or with manual intervention, the text files that were created at steps 606 and 612 are converted into database records and entered into the personalization/segmentation database. When this operation occurs upon the expiration of a timeout period (step 614), all existing text files are consolidated and compressed by the data aggregation server (step 616). These compressed files are then exported to the personalization/segmentation database (step 618) where they are uncompressed and converted into database records. In the described embodiment, a C Program is used to decompress all of the text files and to convert the text files into a database format. The personalization/segmentation database then enters the records for future use.

Consolidation of records may also be initiated manually (step 620). When manual consolidation is initiated, the text files are consolidated and compressed (step 622) and then the text files are exported to the personalization/segmentation database (step 624). The personalization/segmentation database then decompresses the file and converts the records into a compatible database format.

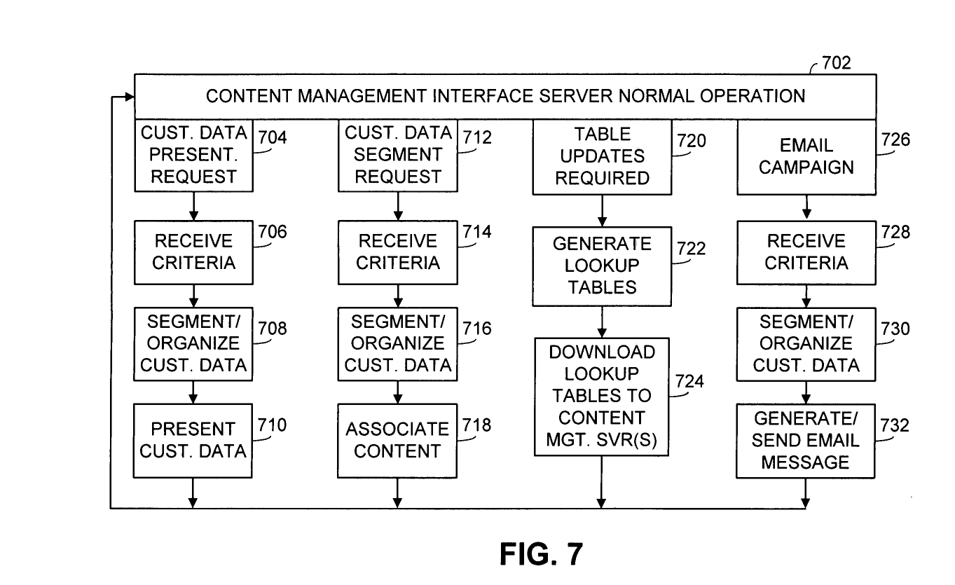

FIG. 7 is a logic diagram illustrating operation of a content management interface server according to the present invention. When a client interfaces with the content management interface server, the client may review the customer activity that has been recorded regarding the client's web site. Operation is initiated with a customer data presentation request made by a client (step 704). Data is presented to the client according to a set of criteria that is set up by the client. Examples of criteria that may be used to present the data include, purchasers vs. non-purchasers, number of purchases, total dollars spent, number of times visited the client site, how the customer reached the site and a number of other criteria. Various summary pages may also be produced which aid the client in attempting to create categories of behavior for its customer base and/or to view all customer data for a particular time period.

The content management interface server then receives the criteria (step 706) and segments the customer data according to the criteria (step 708). The customer data is then presented to the client based upon these criteria and organized according to the set of criteria (step 710).

After a review of the data has revealed particular ways in which the customer should segment customers and how to target personalized content or other content to the customers, the client performs a customer data segmentation request (step 712). The content management interface server receives the criteria for the customer data segmentation request (step 714) and segments/organizes the customer data according to the particular criteria. At the same time, the client provides personalized content corresponding to the customer segmentation. The content management interface server then associates the personalized content with the particular segmentations created (step 718).

Based upon a current segmentation of customer data and associated personalized content, the content management server determines that table (or other logic function) updates are required (step 720). Table updates are performed periodically, e.g., every six hours at a time that is coordinated with the receipt of new data in the personalization/segmentation database from the data aggregation server. Alternately, a table update may be initiated manually, such as is the case when segmentation criteria are updated. When table updates are required, the content management interface server retrieves all pertinent data from the personalization/segmentation database, retrieves the segmentation criteria and generates lookup tables, e.g., hash tables, based upon the data and the segmentation criteria (step 722). These tables are then downloaded to the content management server(s) that is/are servicing the particular client and expID (step 724).

As another operation according to the present invention, the content management interface server creates and generates an email campaign (step 726). This email campaign may be periodically initiated for the client or may be manually initiated by the client. When initiated, the content management server receives criteria for the email campaign (step 728), e.g., particular segments of customers to which the email is directed. The content management interface server then segments/organizes the customer data to retrieve customer entries that correspond to the criteria (step 730). The content management interface server then generates email messages to the customers meeting the segmentation criteria (step 732). The email messages created may have embedded code in the email messages to track the email as well as the subsequent behavior of the recipient, e.g., click through to the client web site and an ultimate purchase. Email addresses may be collected by the PCDC during operations when the customer orders from the corresponding client. In an alternate operation, the job of creating and sending the email is contracted out to a third party.

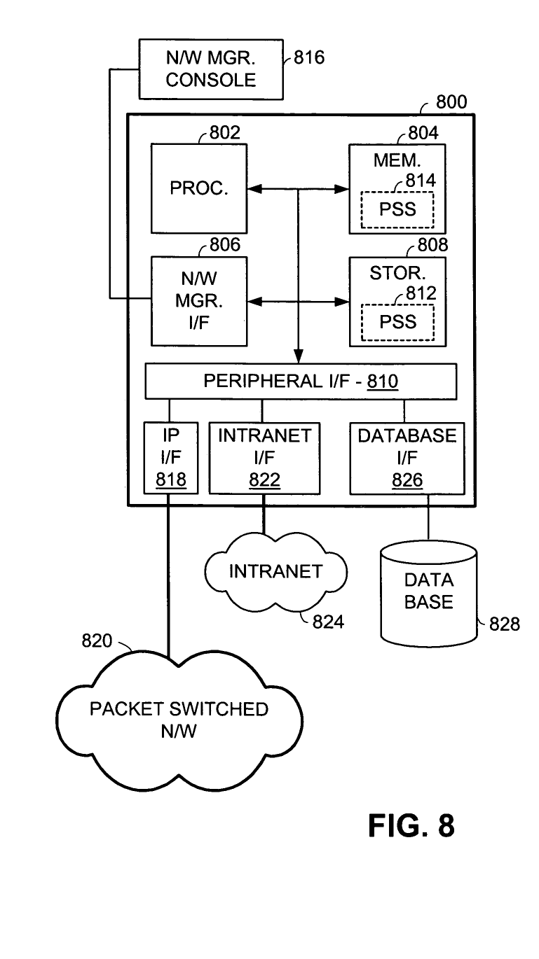

FIG. 8 is a block diagram illustrating a server computer constructed according to the present invention that may perform the functions of the content management server (108), the data aggregation server (112) or the content management interface server (116). The server computer (800) may be a general-purpose computer that has been programmed and/or otherwise modified to perform the particular operations described herein. However, the server computer (800) may be specially constructed to perform the operations described herein. The server computer (800) may also provide the functionality of the content server (110), the client web server(s) (104) and/or the third party web server(s) (106).

The server computer (800) includes a processor (802), memory 804, a network manager interface (806), storage (808) and a peripheral interface (810), all of which couple via a processor bus. The processor (802) may be a microprocessor or another type of processor that executes software instructions to accomplish programmed functions. The memory (804) may include DRAM, SRAM, ROM, PROM, EPROM, EEPROM, or another type of memory in which digital information may be stored. The storage (808) may be magnetic disk storage, magnetic tape storage, optical storage, or any other type of device, which is capable of storing digital instructions and data.

The network manager interface (806) couples to a network manager console (816), which allows a manager to interface with the server computer (800). The network manager console (816) may be a keypad/mouse/display or may be a more complex device, such as a personal computer, which allows the manager to interface with the server computer 800.

The peripheral interface (810) couples to a packet switched network interface (818), an Intranet interface (822) and a database interface (826). The packet switched network interface couples the server computer (800) to a packet switched network (820) that may be the Internet (WWW) or another packet switched network. The Intranet interface (822) couples the server computer (800) to an Intranet (824). In one embodiment, the server computer (800) couples to the Internet via the Intranet (824). The server computer (800) may use the Intranet (824) to access resources that are not coupled to the Internet.

The database interface (826) couples the server computer (800) to a database (828) (when included) that stores content and data relating to the personalization and segmentation functions according to the present invention. Personalization and Segmentation Software (PSS) (812) is loaded into the storage 808 of the server computer (800). Upon its execution, a portion of the PSS (812) is downloaded into memory (804) (as PSS 814). The processor (802) then executes the PSS (814) instructions to perform the operations described herein. The programming and operation of digital computers is generally known to perform such steps. Thus, only the functions performed by the server computer (800) will be described and not the manner in which the processor (802) and the other components of the server computer (800) function to perform these operations.

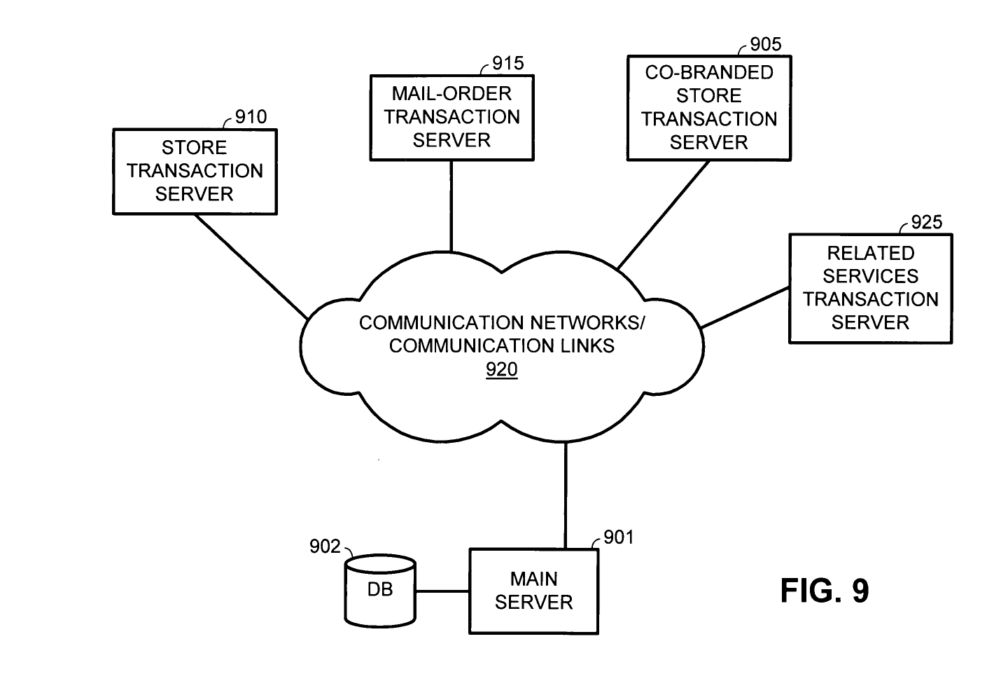

FIG. 9 is a block diagram illustrating a particular embodiment of a data accumulation and segmentation system of the present invention. This system is comprised of a main server (901) that stores data accumulated from various sources and various media. The main server (901) may be the same server as the content management interface server (116) illustrated in FIG. 1 and discussed further with reference to FIGS. 2-8. However, in other embodiments, the main server (901) is separate and distinct from the content management interface server (116) but interfaces therewith to accomplish the teachings of the present invention. The main server (901) is typically owned and operated by a data accumulation company that handles the storage and use of the accumulated data. However, in other embodiments, the main server (901) is operated by a company that also is engaged in commerce with respect to the information collected and used thereby.

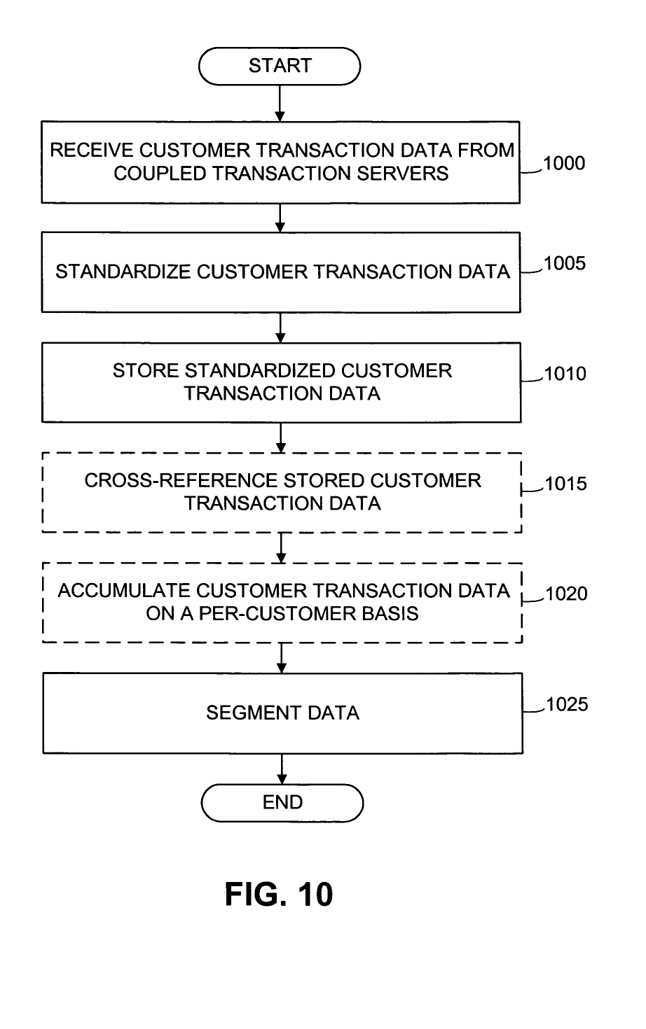

Customer data that is collected by and stored by the main server (902) is accumulated from a wide range of sources such as stores or mail order, such sources including e-commerce and non-e-commerce sources. Each of the sources of customer data interfaces with the main server to acquire customers' personal data, transaction data, and other pertinent data for later use in focused advertising to those customers. These operations will be described further herein with reference to FIGS. 10-12. A customer database (902) couples to the main server (901) and may be employed to store collected data that has been ordered and/or normalized. In one embodiment, the customer database (902) is the same database as the personalization/segmentation database (114) illustrated in FIG. 1. However, in other embodiments, the customer database (902) is separate and distinct from the personalization/segmentation database (114). In the latter case, the data stored in the customer database (902) will eventually be passed, either in a same or similar form, to the personalization/segmentation database (114) for subsequent segmentation/advertising efforts.

Coupled to the main server (901) via one or more communication networks/links (920) are a store transaction server (910), a mail order transaction server (915), a co-branded store transaction server (905) and a related services transaction server (925). These servers 905, 910, 920, and 925 are generalized representations of the various computer devices that service transactions with customers. The descriptions of these servers 905, 910, 920 and 925 is intended to generally relate the various types of systems in place that service transactions with customers. Of course, any various other computer server (or other computer equipment) that services customer transactions could be coupled to the communication networks/links (920) as well and fall within the scope of the present invention. Each of these servers 905, 910, 920, and 925 includes at least one structure for storing data. In one contemplated embodiment, the structure is a hard drive storage unit operated in conjunction with a database program.

The communication networks/communication links (920) refers generally to any network or communication system that services data communications between the main server (901) and the store transaction server (910), the mail order transaction server (915), the co-branded store transaction server (905), the related services transaction server (925), or another server/computer that stores customer transaction data. The communication networks/communication links (920) could comprise one or more of the Internet, a Wide Area Network, a Local Area Network, an Intranet, one or more portions of the PSTN, a wireless network, a satellite network and/or any other communication network that supports communications between computers.

As an example of a portion of the operation of the data accumulation and segmentation system, a customer purchases an item from a co-branded store in a mall or other location. The customer's identity, other personal information and transaction information is stored on the co-branded store transaction server (910). This information includes at least the date of purchase, the customer's name, the customer's age, the customer's address, the item purchased, and the amount of purchase. However, additional information may also be stored on this server including, for example, a customer number, relationships of the customer to other customers, etc. Either immediately, or periodically at a chosen interval of time or transaction numbers, this transaction information, as well as all other stored but not previously uploaded information, is sent to the main server (901) via the communication network/communication links (920).

In another example of such an operation, a customer makes a mail-order purchase with a mail order vendor. In servicing this mail-order purchase, the mail-order transaction server (915) collects and stores all relevant customer and transaction information for the purchase. This information is then sent, either immediately, or periodically to the main server (901). In still another

As another example, the customer purchase an item from a co-branded store of another company that has a business relationship with another corporation interested in collecting customer transaction data. The co-branded stores may include various types of stores that sell goods different than that of the interested corporation but use the trademarks of the interested corporation. An example of such co-branding relationship is the relationship that exists between the Ford Motor Company™ and the Eddie Bauer™ sporting goods and apparel companies. Some of Ford Motor Company's vehicles carry the Eddie Bauer™ brand. The Eddie Bauer™ Company has an interest in determining who purchases vehicles carrying its brands for subsequent advertising efforts. In such an example, the co-branded store customer transaction server (910) collects customer transaction data for the co-branded goods. Then, this customer transaction information is sent to the main server 901 for subsequent use.

As a further example, a customer purchases from multiple stores that are owned by a common corporate parent, each of which operates a store transaction server (910). These commonly owned stores might include various clothing stores specializing in different levels of clothing cost, style, or the customer's sex. The corporate parent of the stores may also have a mail order business that sells the same or similar products via telephone or Internet, which uses a mail-order transaction server (915). Customer transaction information from all of these stores and purchases will be sent to the main server (901) for further action in advertising by the common corporate parent. Such advertising may attempt to direct one type of purchaser from a lower priced commonly owned store at which the customer currently shops to a higher priced commonly owned store at which the common corporate parent may make a larger profit on similar sales.

As still another example, the customer may purchase services that are of interest to another company for subsequent advertising/sales efforts. For example, the customer may be a woman in the hospital who has just delivered a baby. The hospital's corporate parent may own or have a deal with other stores that sell baby apparel or other baby requirements. The mother's personal information as well as the baby's information is entered into the hospital's related services transaction server (925) for later downloading.

The information from all of the various sources illustrated in FIG. 9 is accumulated in the main server (901). In one embodiment, the main server (901) accumulates this information by automatically telephoning each source's database and downloading the information. For example, the main server and each of the individual consumer transaction database servers are coupled to or are comprised of a modem that is coupled to the public switched telephone network (PSTN). The main server, through the modems and PSTN, telephones each subscribing database late at night when the stores are closed and the databases have been updated for the day. Alternatively, each store's database server can call the main server (901) and download the information.

In another embodiment, the various sources of customer transaction data are linked to the main server (901) by satellite. In this case, the main server (901) can either accumulate the data in real-time as the customer makes the purchase or the information can be downloaded to the main server after the store has closed for the day. This embodiment requires that each server be coupled to a satellite transceiver and satellite antenna. In still another embodiment, the main server (901) is coupled to the consumer transaction database servers over a dedicated data line such as an ISDN line. This requires that each server be coupled to an ISDN modem.

The embodiment of FIG. 9 shows the main server (901) as being a single server. Alternate embodiments use multiple physical servers that may include multiple hard/tape drives for mass storage of the data. Further, multiple databases (902) may also be used, either in shared or dedicated modes.

FIG. 10 is a flowchart illustrating a process of data accumulation and segmentation in accordance with the system of FIG. 9. As the data is being accumulated into the main server's (901) database (step 1000), the process must first standardize the data into a common format (step 1005) in order for the data to be useful.

Each server/computer, e.g., 905, 910, 915, and 925, that has accumulated data may have its own proprietary format for storing the customer/transaction data. In this case, each different data format must be re-organized such that each piece of customer information is stored in a known order in the database. The order or predetermined format of the data can be any order with delimiting characters, such as a semicolon, to differentiate the different fields of data. The following shows an example of a data format:

Last Name; First Name; Age; Address; Item Purchased; Price Paid; Retailer Name

After the data is standardized (step 1005), it is stored in the main server (901) (step 1010). Next, the data may be cross-referenced (step 1015) to determine the customer's shopping patterns and habits. In other words, the customer's transactions from all of his purchases at different retailers are examined. Step 1015 is optional and may encompass all, some or none of the steps previously described herein for segmenting customer data.

If the customer only made purchases from high-end retail establishments, he should not be targeted with advertisements from low-end establishments. Additionally, if the customer is a female, she should not receive advertisements for male-oriented items. Or if the customer is relatively young, she should not receive advertisements related to older adult items.

After cross-referencing the data (step 1015), the data is optionally accumulated on a per customer basis (step 1020). In other words, on the main server (901), each customer will have a file dedicated solely to that customer that can be referenced by the customer's name, telephone number, or other indication. In another operation, the data is incorporated into the personalization/segmentation database (114) of FIG. 1 for further operations.

The customer file includes: the aggregate spending habits that have been accumulated from the various sources, the customer's address, the dates and locations of the various purchases, the customer's age and sex, and any other relevant information that can be accumulated from the above described databases.

The accumulated customer files are then segmented (1025). Segmentation, as described above in relation to other embodiments, is a technique for identifying a group of customers by defining the group's characteristics. The process of the present invention, therefore, not only gives the subscribing retailer information regarding each individual customer but also enables the retailer to target groups of customers based on the segmented data. Once the data is stored in the main server's database, it can be used for multiple purposes.

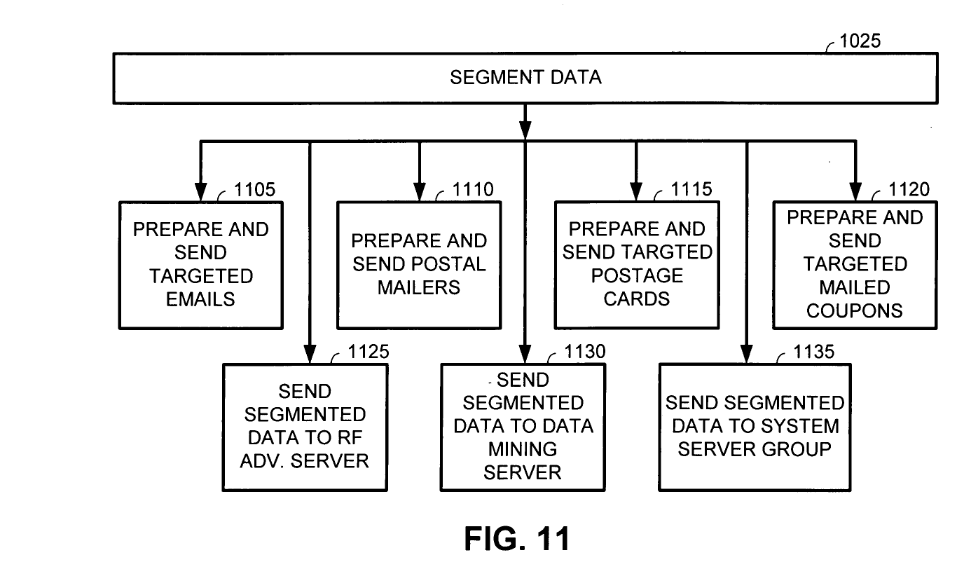

FIG. 11 is a flowchart illustrating a process that uses the accumulated/segmented data in accordance with the system of FIG. 9. After the data is segmented (step 1025), it may be used to direct targeted emails to the individuals (step 1105) that advertise the retailers' products. The segmented data may also be used to direct targeted postal mailers or brochures (step 1110), post cards (step 1115), and/or coupons (step 1120). In another embodiment, if the customer possesses a web-enabled cellular telephone, the data can be used to send advertisements/discounts to that particular telephone for display on the telephone.

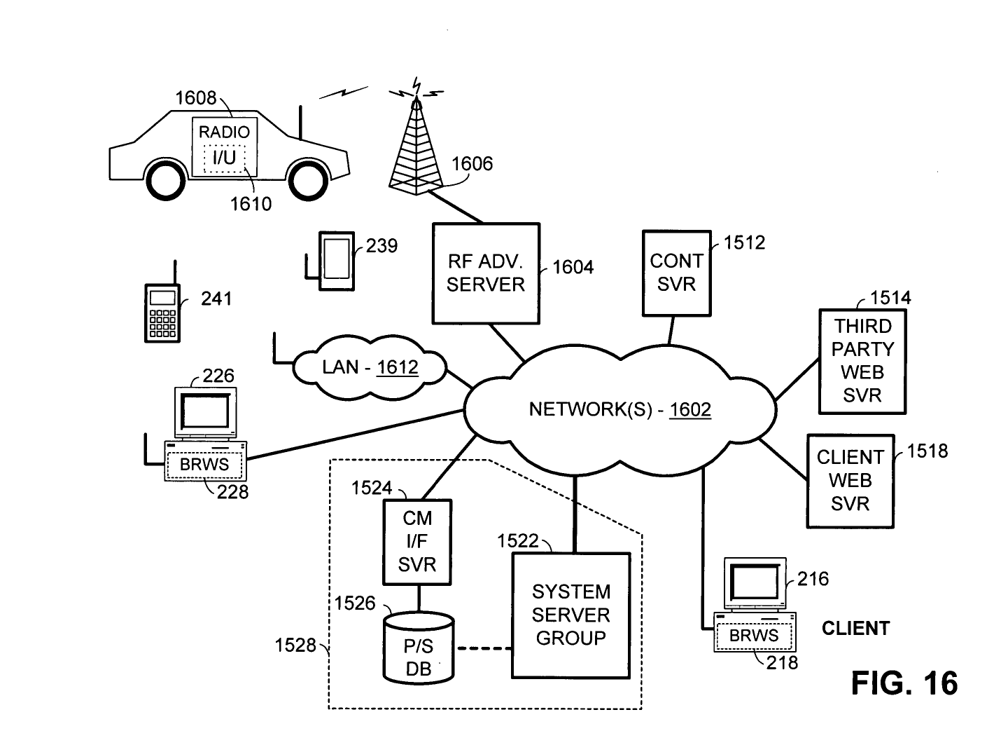

Segmented data may also be sent to an RF advertising server (as will be described with reference to FIG. 16)(step 1125), to a data-mining server for further use (step 1130) and/or to a system server group for use by a client or for a client (step 1135). As will be appreciated from the teachings of FIG. 11, segmented data may be used for numerous useful purposes, only some of which are disclosed herein.

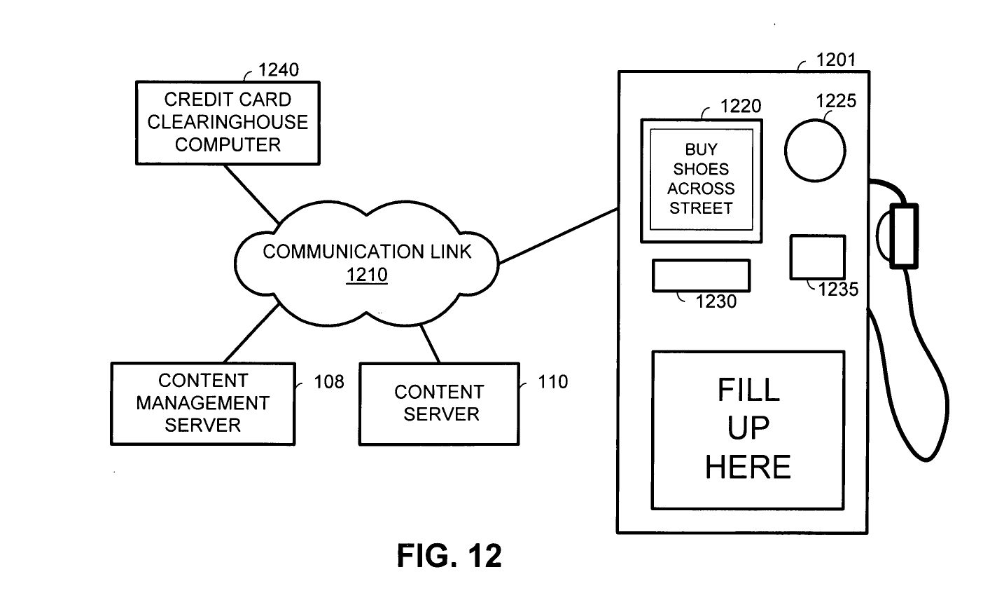

FIG. 12 is a block diagram illustrating a system in which targeted advertising is employed to reach a customer that is accessing a gas pump (1201). In this embodiment, the gas pump (1201) is equipped with means for displaying both video and audio information. This may be accomplished by a CRT or LCD screen (1220) that is capable of video display as well as a speaker (1225) in or near the gas pump (1201).

The gas pump (1201) has is communicatively coupled to the content management server (108) via a communication link (1210), which may include the Internet, the telephone network, a wireless network, etc. This communication link (1210) also couples the gas pump (1201) to a credit card clearinghouse computer (1240). When the customer inserts his credit or debit card into the pump's card reader (1230), his credit information is read from the magnetic strip and sent to a credit card clearinghouse computer (1240) for confirmation of credit. Subsequently, the credit card clearinghouse computer (1240) and/or the gas pump interact with the content management server (108) to request directed advertising for the customer. The content management server (108) complies by either providing directed content to the gas pump (1201) or by directing the gas pump (1201) to retrieve directed advertising content from a content server (110) also coupled to the communication link (1210).

The pump's physical address may be used in conjunction with the customer's identity to determine which advertisements or discounts to display on the pump's audio and video system (1220 and 1225). For example, if a shoe store is across the street and that particular customer purchased a pair of shoes there or at a co-branded store a predetermined time in the past; the pump may display an advertisement and/or a discount for shoes at that establishment. The predetermined time may be the average life span of a pair of shoes such that the customer gets the advertisement at the time his shoes have likely worn out.

Since the gas pump (1201) also has a printer (1235) to print receipts for the gas sale, the printer (1235) may also print a coupon for the discounted shoes. The printer (1235) may also print coupons for other retailers or for directions to any retailer. 1001201 In another embodiment, if the gas pump equipment is set up for input by the customer, the customer may perform a purchase at the same time he is pumping gas. Different embodiments of such input devices include touch screen displays, miniature keypads, and other devices for entering data. This purchase may be for the delivery of goods to his or her home, e.g., delivery of a pizza if the customer is on his or her way home, delivery of groceries, durable goods, etc.

Since the pump is coupled to the customer's information over the communication link (1210), it can verify the customer's shipping address, allowing the customer to purchase an item and have it shipped to the address of record. The customer may be required to input a password or other means of verifying identity to prevent a stolen credit card from being used to obtain a customer's address.

The teachings of the present invention set forth in FIG. 12 are not limited to gas pumps. These teachings may be applied to cash machines, vending machines, coupon vending machines, and other machines that may identify a customer, interact with the content management server 108 and provide advertisements/marketing materials to the customer.

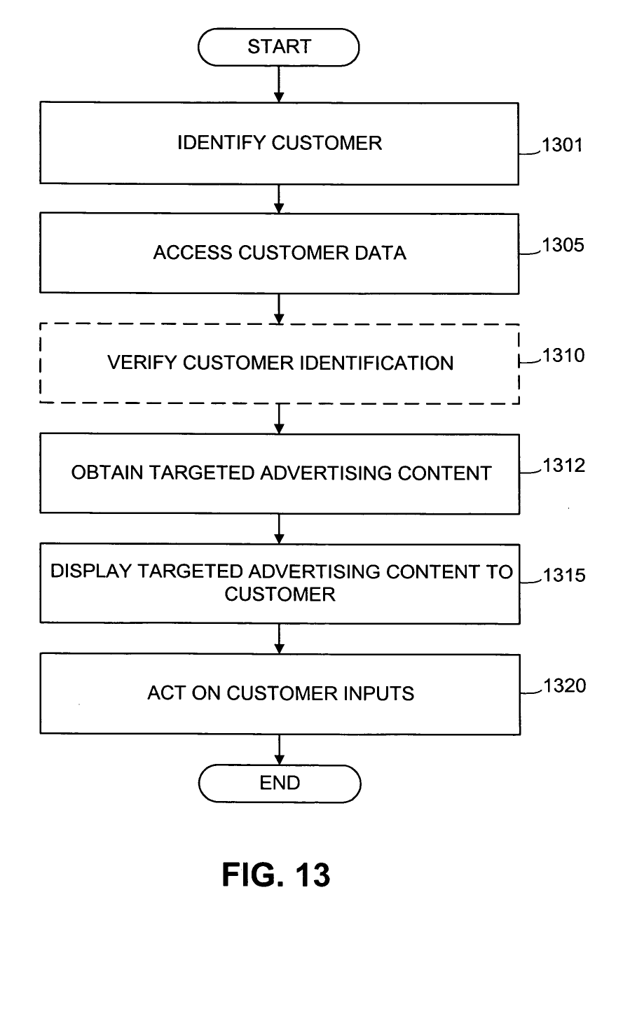

FIG. 13 is a flowchart illustrating a process in accordance with FIG. 12 in which the customer is identified by the use of his credit card, such as the gas pump example described in FIG. 12. The process begins by the identification of the customer (step 1301). This process may be performed by the gas pump (1201), the credit card clearinghouse computer (1240) or by other means. Once the customer's identity has been established, a query is sent to the content management server (step 1305). As an optional step, the customer may be asked for a password, PIN, or other means of verifying the customer's identity (step 1310).

Once the customer has been properly identified, the content management server identifies the advertising content targeted to the customer. The content management server (108) either delivers the content or directs the gas pump (1201) to retrieve content from the content server 110 (step 1312). The advertising content is then displayed to the customer (step 1315) on the audio/video system. If the system provides an input mechanism for the customer to act on the advertisements or offers for sales, the system then provides the proper responses (step 1320).

These acts include printing out coupons, closing a sale using the customer's already entered credit information, or shipping the ordered item to the chosen address. Additionally, the acts could include printing out directions to the nearest desired retailer.

In summary, the system and processes of the present invention provide retailers with the ability to focus advertisements at customers based on the customer's spending habits and lifestyle. This provides multiple benefits for both the retailers and the customers.

The present invention saves the retailer money by avoiding the spending of advertising dollars on someone who has no interest in the retailer's product. The potential customer does not receive advertisements that are considered a nuisance to him or her. The present invention also pushes the customer/potential customer to a particular sales channel such as the physical store or an Internet address. The present invention, therefore, promotes a relaxed, low-pressure sales environment for both the customer/potential customer and the retailer.

FIG. 14 is a system diagram illustrating an alternate embodiment of a personalized content delivery system constructed according to the present invention in which content is accessed and delivered via separate networks. As shown, a system server group (207), a content management interface server (212), a client computer (216) running a browser (218), a client web server (220), a third party web server (222), and a content server (224) couple to a first network(s) (1402). A content server (1404) and an interworking function (1410) couple the first network(s) (1402) to a second network(s) (1404). A client content site (1406) also couples to the second network(s) (1404). In the illustrated embodiment, the first network(s) (1402) is a combination of data networks supporting a relatively lower data rate and a differing content mix than does the second network(s) (1404). One particular example of the first network(s) (1404) includes the Internet and a wireless data network. In this particular example, the second network(s) includes a cable television network.

In the system of FIG. 14, content is accessed via the first network(s) (1402) and delivered via the second network(s) (1404). In one operation, a web enabled telephone (241) operated by a user accesses client web server (220). PCDC is downloaded to the web enabled telephone (241), which, upon execution directs the web-enabled telephone (241) to content stored upon the client content site (1406). However, the web-enabled telephone (241) is incapable of receiving the content, streamed video. Thus, the web-enabled telephone (241), the system server group (207) and customer computer (226) running browser (228) interact so that the content is delivered from the client content site (1406) to the customer computer (226). In a particular operation of this type, the web-enabled telephone (241) initiates this alternate delivery scheme. However, in another embodiment, a prior registration with the system server group (207) results in the delivery of the content to the customer computer (226).

In a second operation according to the present invention, customer computer (1412) running browser (1414) couples to the first network(s) (1402) and accesses third party web server (222). PCDC downloaded from the third party web server (222) causes the customer computer (1412) to access the system server group (207). In response, based upon interaction between the customer computer (1412) and the system server group (207), the system server group (207) directs content from the client content site to be delivered to the customer via customer television (1418). The client content site (1406) then delivers streamed video content via the second network(s) (1404) to the customer television (1418).

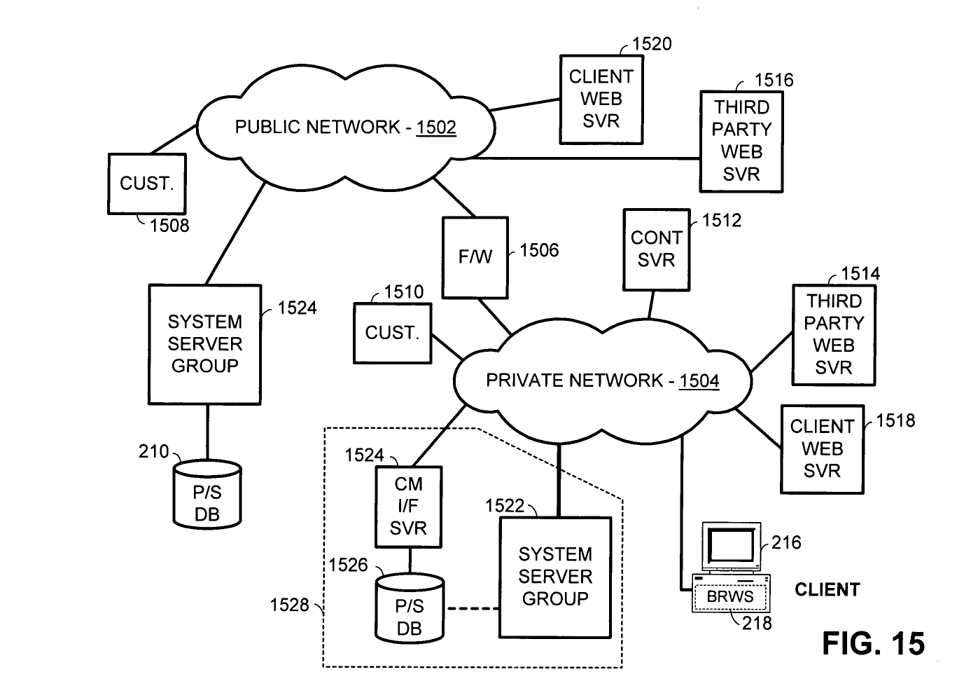

FIG. 15 is a system diagram illustrating another alternate embodiment of a personalized content delivery system constructed according to the present invention in which a first system server group services a single client and a second system server group services a plurality of clients. In the embodiment, a client system group (1528) includes a system server group (1522), a content management interface server (1524) and a personalization database (1526). The client system group (1528) couples to a private network (1504), both of which are operated by the client. A client computer (216) running browser (218), a third party web server (1514) and a client web server (1518) also couple to the private network (1504). The private network (1504) may be a service provider's, e.g., AOL, Earthlink, Prodigy, etc., the Intranet of a corporation, or another type of private network. A content server (1512) and a customer computer (1510) also couple to the private network (1504).

The private network (1504) couples to a public network (1502) via a firewall (1506). A client web server (1520), a third party web server (1516), a customer computer (1508) and a system server group (1524) also couple to the public network (1502). A personalization database (210) couples to the system server group (1524). Thus, as illustrated in FIG. 15, a client may operate its own system group (1528), acquiring the equipment, maintaining the equipment and not relying upon a service provider. In this case, the client may collect its own customer data, segment its own customer data, and service all customer queries according to the present invention. Alternately, the client may receive segmented data from a service provider, such as was illustrated in FIG. 11. The system group (1528) serves as an integrated solution for providing personalized content to its customer base.

FIG. 16 is a system diagram illustrating still another embodiment of a personalized content delivery system constructed according to the present invention in which radio frequency (RF) watermarks are employed in delivering personalized content. In the system of FIG. 16, a client system group (1528) includes a system server group (1522), a content management interface server (1524) and a personalization database (1526). The client system group (1528) couples to network(s) (1602). A client computer (216) running browser (218), a third party web server (1514) and a client web server (1518) also couple to the network(s) (1602). A content server (1512), a RF advertising server (1604), and a local area network (LAN) (1612) also couple to the network(s) (1602). A RF transmitter (1606), operated by a RF broadcast station also couples to the RF advertising server (1604).

In an operation according to the present invention performed by the components illustrated in FIG. 16, the RF transmitter (1606) transmits programming, which includes RF watermarks. The RF watermarks associate with the programming and allow for later correlation with the programming. In an example of such RF watermark association, each commercial played by the radio station includes a particular RF watermark. A radio (1608) in a customer's car records the RF watermarks for programming received by the customer. The radio (1608) includes an interface unit (1610) that downloads the RF watermarks to a PDA (239), a web-enabled telephone (241) and/or a customer computer (226) operating browser (228). Such downloaded information may also include a description of the programming, a link to a corresponding web site, or other relevant information, if such description is also transmitted by the radio station via the RF transmitter (1606). In a typical operation, the radio (1608) stores a number, e.g., 25, of the most recent RF watermarks received. All or a portion of these RF watermarks may be downloaded to another customer device, e.g., customer computer (226).

The system of the present invention uses these watermarks to identify web sites corresponding to the RF watermarks. With the RF watermarks downloaded to another customer computer (226), the customer device, via interaction with the RF advertising server (1604) or another server, may identify a web site associated with the RF watermark. The customer then accesses this web site using the customer computer (226) and accesses the web site, e.g., at client web server 1518. Upon access, the customer computer (226) downloads PCDC, which it then executes to generate a query. Included in this query is the RF watermark received by the customer. The client system group (1528), in responding to the customer query, uses the RF watermark to select personalized content for the customer. For example, the RF watermark may correspond to an advertisement that offered 20% off if responding via the client web server (1518). By identifying the RF watermark as corresponding to the advertisement, the client system group (1528) may then automatically extend the 20% off offer to the responding customer. In another example, the RF watermark corresponds to an advertisement for particular goods. Thus, the client system group (1528) uses the RF watermark to select content relating to the advertised goods.

The invention disclosed herein is susceptible to various modifications and alternative forms. Specific embodiments have been shown by way of example in the drawings and detailed description. It should be understood, however, that the drawings and detailed description thereto are not intended to limit the invention to the particular form disclosed, but on the contrary, the invention is to cover all modifications, equivalents and alternatives falling within the spirit and scope of the present invention as defined by the claims.

1. A system comprising:
a web page that is downloadable from a web server to an e-commerce customer computer, the web page comprising:
at least one image to be displayed on the e-commerce customer computer; and
a personalized content delivery code to be executed by the e-commerce customer computer that causes the e-commerce customer computer to:
send a query to a content management server that includes the identity of the e-commerce customer; and
a content management server to receive the query from the e-commerce customer computer via a communications network, the content management server storing customer attributes, the content management server identifying personalized content to be communicated to the e-commerce customer computer based on the customer attributes, and delivering the personalized content based upon an identity of an e-commerce customer.

2. The system of claim 1, wherein the e-commerce customer attributes include at least one perceived consumer preference and wherein the content management server identifies the personalized content to be communicated to the e-commerce customer based on the customer attributes.

3. The system as in claim 2 further comprising:
receiving a response from the e-commerce customer responsive to delivered personalized content; and
modifying the customer preference based on the received response.

4. The method of claim 3, wherein the perceived consumer preference is determined based on the e-commerce customer's reaction to the delivered personalized content.

5. The method of claim 4 wherein a positive e-commerce customer response is received by the content management server and stored at the content management server.

6. The method of claim 5 wherein the customer's preference is based upon prior positive e-commerce customer responses.

7. The method of claim 2, wherein the perceived consumer preference is a propensity of a consumer to purchase goods related to one of a trademark, a price range, a geographic location, a season, a sex, a service, an item under current ownership of the customer, a birthday, and a holiday.

8. An advertising method comprising:
creating a first sales data file responsive to a first method of achieving a first sale via a first sales channel;
creating a second sales data file responsive to a second method of achieving a second sale via a second sales channel;
standardizing the first sales data file with the second sales data file when the first sales data file has a different format than the second sales data file to create standardized consumer data;
grouping consumer characteristics responsive to the standardized consumer data to create at least one target group; and
assigning an advertisement to the at least one target group.

9. The method as in claim 8, wherein the first sales channel is an e-commerce sales channel and the second sales channel is a non e-commerce sales channel.

10. The method as in claim 8, wherein the first sales channel is an e-commerce channel and the second sales channel is a store-based retail sales channel.

11. The method as in claim 8, wherein the first method of achieving a first sale is a cash method and the second method is a credit method.

12. The method as in claim 8, wherein the first sales channel is a mail order channel and the second sales channel is a store based retail channel.

13. The method as in claim 8, wherein the first sales channel is a mail order channel and the second channel is an e-commerce channel.

14. A sales data processing method comprising:
creating a first sales data file responsive to a first set of data associated with a first sale over a first sales channel by a first vendor, the first set of data having a first consumer identifier;
creating a second sales data file responsive to a second set of data associated with a second sales channel by a second vendor the second set of data having a second consumer identifier;
standardizing the first sales data file with the second sales data file when the first sales data file has a different format than the second sales data file to create standardized consumer data;
segmenting the standardized consumer data utilizing the first and second consumer identifier such that the first and second vendor can acquire consumer data over a broad range of sales channels; and, advertising utilizing the acquired consumer data and the standardized consumer data.

15. The method as in claim 14, wherein the first sale is a transaction in goods and the second sale is a transaction in goods.

16. The method as in claim 14, wherein the first sale is a transaction in services and the second sale is a transaction in goods.

17. The method as in claim 14 where the first sale is a transaction in services and the second sale is a transaction in services.

18. The method as in claim 14 further comprising collating data files from the standardized consumer data based on the consumer identifiers associated with the first sale and the second sale.

19. The method as in claim 14, wherein the first sale is a mail order sale and the second sale is an e-commerce sale.

20. A method of target advertising comprising:
compiling sales data from a plurality of data servers supporting a plurality of distinct sales channels;
standardizing the compiled sales data into a common data format to generate standardized sales data;
segmenting the standardized sales data into categories based upon characteristics of the sales data; and
providing a targeted advertisement responsive to the categories.

21. The method of claim 20, wherein the plurality of sales channels are comprised of at least two of an e-commerce, service provider, retail store, mail order, and a self service distribution channel.

22. The method of claim 20, wherein the plurality of data servers are coupled to a communications network.

23. The method of claim 20, wherein one of the servers of the plurality of data servers is a credit card clearinghouse computer.

24. The method of claim 20, wherein at least one of the plurality of data servers provides online e-commerce transactional data and wherein at least one of the plurality of data servers provides offline transactional data.

25. The method of claim 20, wherein at least one of the plurality of data servers provides online e-commerce sales data and wherein at least one of the plurality of data servers provides offline sales data.

26. The method of claim 20 further comprising selecting an advertising media based on the standardized segmented data.

27. The method of claim 20, wherein the step of compiling further comprises establishing a network connection between the plurality of data servers.

28. The method of claim 20, wherein the advertising media is one of a gas pump, television, radio, hand delivered mail, electronic mail, and an automatic teller machine.

29. The method of claim 20, wherein the advertising data is provided in real-time in response to a current customer activity.
